(19) United States
(12) Patent Application Publication
(10) Pub. No.: US 2005/0108022 A1
(43) Pub. Date: May 19, 2005

(54) System and mechanism to create autonomic business process solutions

(76) Inventors: Kamal Bhattacharya, Pleasantville, NY (US); Ying Huang, Yorktown, NY (US); Jun-Jang Jeng, Armonk, NY (US); Shubir Kapoor, Mohegan Lake, NY (US); Santhosh Kumaran, Croton On Hudson, NY (US); Yingjie Li, Columbus, OH (US); Anil Nigam, Stamford, CT (US); Frederick Y. Wu, Cos Cob, CT (US); Liangzhao Zeng, Ossining, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/706,040

(22) Filed: Nov. 13, 2003

(51) Int. Cl. G06F 17/60

(52) U.S. Cl. 705/1

(57) ABSTRACT

Automomic business processes management solutions have capabilities to adapt themselves to changes in the business environment. These autonomic business solutions are built by wiring together autonomic solution components called BPbots (Business Process robots). BPbots are granular solution components representing an aspect of a business process. In general, BPbots consist of two parts, an execution module and a managerial module. The execution module represents the standard, non-autonomic solution component, such as a standard process flow model describing the long-running flow or business adapter describing the communication of the solution with service providers (such as applications). The managerial module is responsible for the autonomic behavior of the BPbot. The managerial component has the ability to monitor the execution module, analyze the performance, plan new, more appropriate execution patterns and change the behavior of the execution module according to the new plan.

### BACKGROUND OF THE INVENTION

1. Field of the Invention

The present invention relates to self-adapting, autonomous business processes that have capabilities to adapt themselves to changes in the business environment.

2. Background Description

Business processes describe the behavior of a business. Due to the wide acceptance of web services related technologies, many new concepts and technologies have been proposed to support business process integration and management. The goal is to create an Information Technology (IT) solution which represents the behavior of the business process as it is. Successful businesses, however, distinguish themselves by their ability to adapt to changing business conditions. The ability to sense changes in the business environment and respond to the changes appropriately are limited by today's IT systems design. IT systems often allow for sensing infrastructure to enable monitoring of the business process. Responding to events, however, often entails changes in the IT systems requiring costly manual changes and thereby human involvement at different levels.

### SUMMARY OF THE INVENTION

It is therefore an object of the present invention to provide automomic business processes management solutions that have capabilities to adapt themselves to changes in the business environment.

According to the invention, autonomic business solutions are built by wiring together autonomic solution components called BPbots (Business Process robots). BPbots are granular solution components representing an aspect of a business process. In general, BPbots consist of two parts, an execution module and a managerial module. The execution module represents the standard, non-autonomic solution component, such as a standard process flow model describing the long-running flow or business adapter describing the communication of the solution with service providers (such as applications). The managerial module is responsible for the autonomic behavior of the BPbot. The managerial component has the ability to monitor the execution module, analyze the performance, plan new, more appropriate execution patterns and change the behavior of the execution module according to the new plan.

BPbots can be used to describe the business process behavior at different levels. The key to undeerstanding how BPbot enable autonomoic behavior is the notion of BPbot composition. BPbot communities can be composed in a hierarchical fashion or with independent BPbots, which work collectively towards achieving the targeted business goal. BPbots being the fundamental autonomic solution components to be wired together representing an autonomic business process will necessitate the overall construct to be a BPbot, as well. This implies that the autonomic business process solution is a BPbot, which consists of a managerial unit and execution modules. From this perspective, the execution modules are BPbots. If the BPbot community is nested, the managerial module (which can be a BPbot, as well) represents the major point of control in the BPbot community. In a non-hierarchical community, the BPbots are going to be interacting collaboratively to achieve the targeted business goal.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating the BPbot architecture at deploy time;

FIG. 2 is a block diagram illustrating the BPbot at run-time;

FIG. 3 is a block diagram illustrating a BPbot implementation example;

FIG. 4 is a block diagram illustrating a BPbot composition example shown as a hierarchical composition;

FIG. 5 is a block diagram illustrating an application of BPbots in the retail industry; and

FIG. 6 is a block diagram illustrating a BPbot at the business process level containing several nested BPbots.

### DETAILED DESCRIPTION OF A PREFERRED EMBODIMENT OF THE INVENTION

We assume that any business process behavior can be represented by the solution composition of three well-defined components: Adaptive Business Objects (ABO), Workflow, and Adapters.

Adaptive Business objects (ABO) model the executable image of business artifacts. ABOs can be viewed as a model for business records, containing data pertinent to the business process and handed from task to task along the business process. An ABO serves as a dynamic aggregator of distributed business data corresponding to a business artifact and models the life cycle and associated behavior of the business artifact. Augmented finite state machines define ABO behavior. Business events are processed by an ABO based on its state and may trigger state transitions. As part of a state transition, an ABO may execute commands to effect the business enfironment.

Workflows model a sequence of activities. An activity is a unit of collaboration. Typically, a set of activities performed by organizational role players constitutesd a business task (or respectively, a particular state of the ABO). Flow models are use to specify what the activities are, who are performing them, and the control flow between the activities. The activities themselves are defined using augmented finite state machines much like the ABO. But unlike ABOs, activities have no data content.

Adapters are components to mediate information between the business process and a diverse set of agents, such as applications, business partners, etc. There are various representations of adapters, from static, application specific Application Program Interfaces (APIs), to dynamic, state-machine based conversation policies.

Wiring these three components in the right way will enable an IT system, which will exhibit the behavior of the business process. At design time, the components will contain customized models such that the overall behavior of the solution represents the business process behavior. The created IT system, which will execute the models and thereby host the business process, should be designed to allow for changes. This does not mean, however, that changes due to changing business conditions or changing business goals can be managed by the system itself. It will always require human intervention to reconfigure the system manuallyl. To create a truly adaptive system, which is self-managing (and thereby adaptive to changing business conditions) to limit the manual changes to a minimum, the system needs to consist of autonomic solution components. The entire solution for a given business process consists of autonomic components (or BPbots) and an autonomic component or BPbot itself. By the same token, the set of enterprise wide business process should consists of autonomic business processes and be an autonomic business process system itself. BPbots reflect this hierarichal structure in it architecture.

BPbots are autonomic elements which consist of two parts, an execution module and a managerial module. The execution module is a standard solution component (such as ABO, Workflow or Adapters) lacking any inherent self-managing qualities. Execution modules contain the following items:
1. A definition unit that holds the definition of the specific solution component.
2. A definition describing the components' association with the execution engine at run-time.
3. A mechanism to manage the state of the component.
4. A sensor to enable reporting of internal information.
5. An effector to allow for remote access of execution module functionalities.

The managerial module is the main constituent to provide autonomic capabilities. The managerial module controls the behavior of the execution module. Managerial modules consist of the following items:
1. A sensor to communicate information to other components.
2. An effector to receive information from other components outside the BPbot.
3. A monitor module to monitor the messages from the execution module.
4. An analysis module to analyze and evaluate the information from the execution module.
5. A planning module to work out necessary changes and re-plan the execution module.
6. An execution module to execute the suggested changes by creating the right definition for the execution module and changing the execution module behavior appropriately.

In the following, we discuss how an autonomic business process management system is created using BPbots. At the lowest level, a solution component, such as a workflow can be considered as an execution module. The managerial module manages the execution module. Hence, each solution component equipped with a managerial unit is a BPbot. Wiring together several BPbots will crate a business process solution. For example, a purchase order process will have the purchase order as the main business artifact (ABO), several workflows associated with activities executed as different states of the Purchase Order artifact (such as Address Verified, Product Availability Checked, Order Accepted, Product Sent, etc.). Finally, an adapter to store data into a SAP system is needed. The IT solution is created by wiring together the Purchase Order artifact, where different workflows will be executed as different states of the process and the SAP adapter will be used to communicate with the SAP system. In our autonomic solution, all these items, ABO, workflows and SAP adapters, are equipped with a managerial module and thereby are BPbots.

The entire business process is represented by a collection of automatic BPbots, which does not make the business process itself autonomic. To allow for management of the business process from the outside, the collection of BPbots has to be orchestrated by a managerial module.

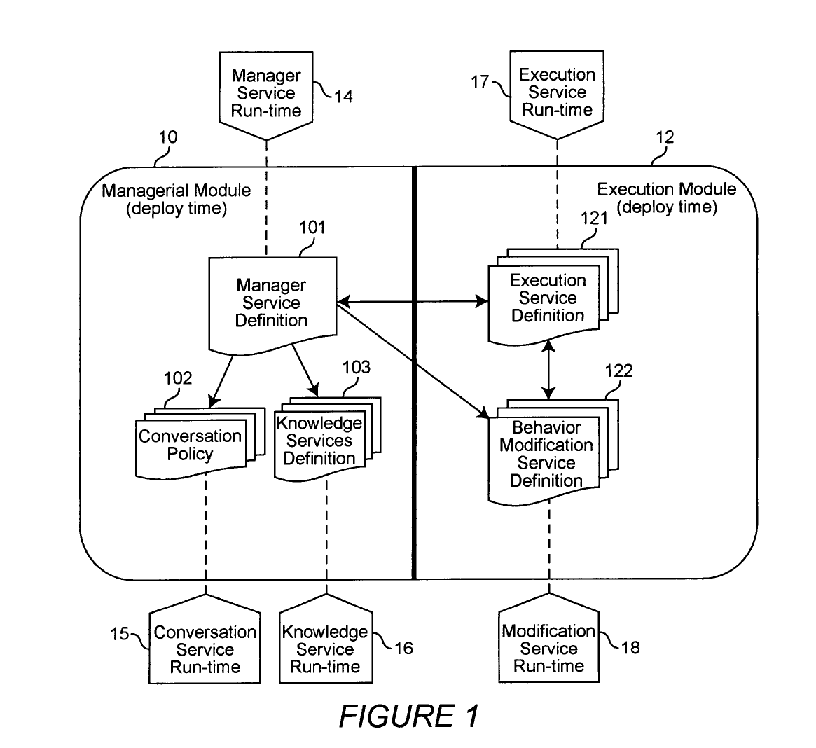

Referring now to the drawings, and more particularly to FIG. 1, there is shown the architecture of a BPbot at deploy time. As mentioned, the BPbot consists of a managerial module 10 and an execution module 12. The managerial module 10 includes at least one manager service definition 101, which describe the basic capabilities of the managerial module. The manager service is capable of creating execution plans for the execution module. The managerial module 10 also includes a plurality of conversation policies (CPs) 102, which are descriptions of communication policies between BPbots, and a plurality of knowledge services 103, which are descriptions of services needed to support the creation of execution plans. The execution module 12 includes a plurality of execution service definitions 121, which describe the basic capabilities of the execution module. The manager service definition 101 and the execution service definitions 121 are linked, as indicted by the double headed arrow. The execution module 12 also includes a plurality of behavior modification service definitions 122, which can be modified by the manager service definition 101 as may be required by changing business conditions.

Different dimensions of BPbot functionality are defined by models. Each model needs to be supported by an adequate run-time environment. This is represented in FIG. 1 by manager service run-time 14 input to the manager service definition 101, conversation service run-time input 15 to conversation policies (CPs) 102, and knowledge service run-time input 16 to knowledge services definitions 103 of the managerial module 10, and by execution service run-time input 17 to execution service definitions 121 and modification service run-time input 18 to behavior modification service definitions 122 of the execution module 12.

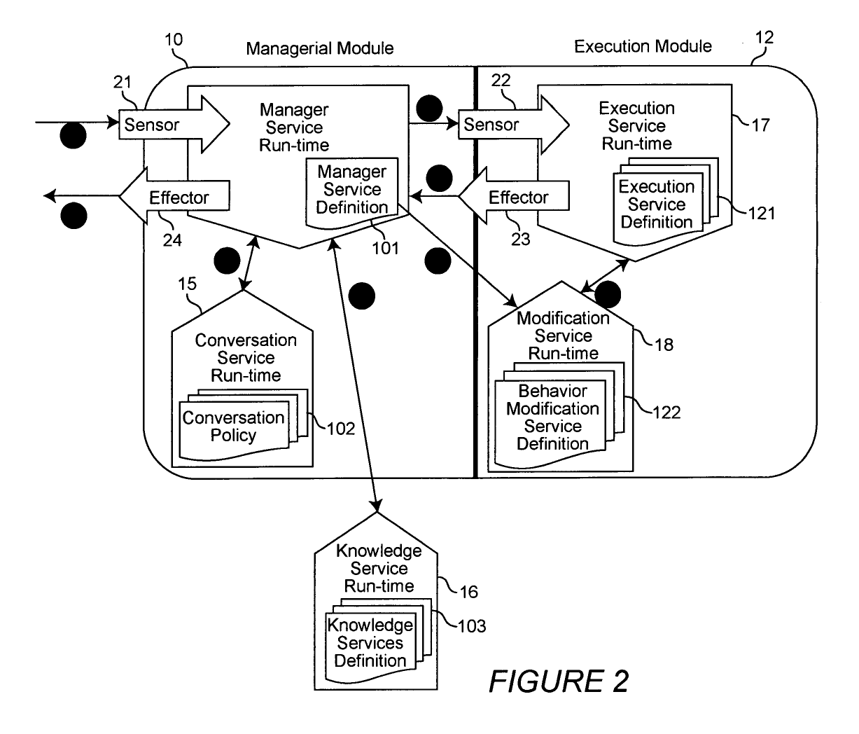

FIG. 2 depicts an example scenario of the internal BPbot execution at run-time. The BPbot manager service run-time 14 exposes a sensor channel 21 through which it receives a message from the outside. The manager service 101 accesses knowledge resources 16. In this example, the knowledge resources are public resources (as opposed to the local conversation policy resources, which are private to the BPbot). The manager service 101 uses the decisions provided by the knowledge service 16 to create an execution plan for the execution module. This execution plan is conveyed to the modification service run-time 18, which stores the execution plan. The manager service 101 sends a message to the execution service to 121 execute the next step. The execution run-time services 17 expose a sensor 22 through which it receives the message from the manager service 101. The execution services 121 checks with the modification service 18 to see whether the manager service 101 has requested a change of execution. The modification service 18 responds by deploying the appropriate execution script based on the execution plan designed by the manger service 101. The execution is thereby changed. The execution service 121 exposes an effector 23, though which the execution result is sent to the manager service 101. The manager service 101 consults the conversation policy 102 to determine the next state in the conversation with another BPbot and determines the required communication protocol. The manager service 101 exposes a an effector 24 and sends the message out.

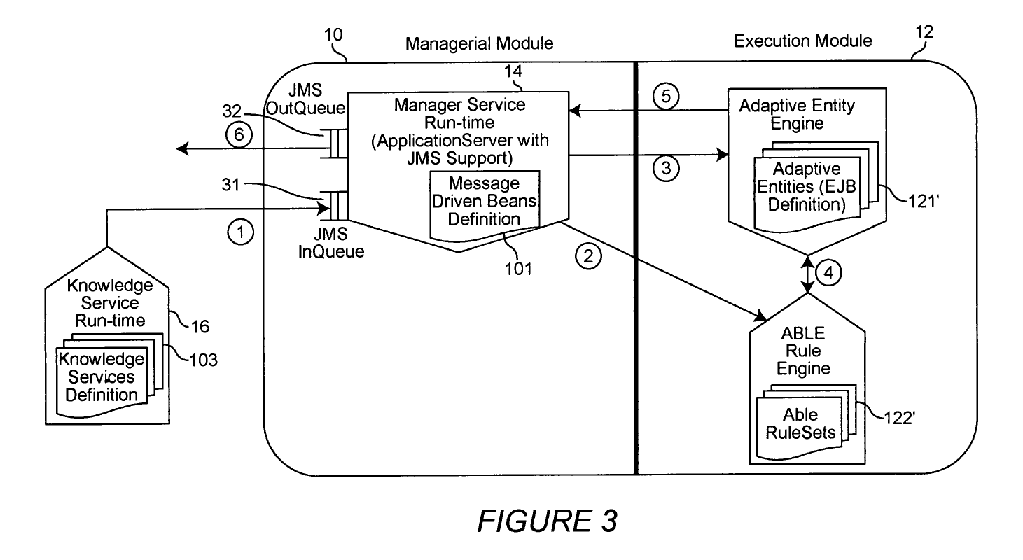

FIG. 3 illustrates one example of a concrete BPbot implementatin allowing for parametric changes to a process flow. In this BPbot implementation, the manger service 101 of the managerial module 10 is realized as a simple message driven JavaBean, which enables a publish-subscribe mechanism to send and receive messages. Furthermore, the manager service 101 has the capability to create rule sets and deploy these rule sets to the ABLE Rule Engine 122′. ABLE is a Java™ framework, component library and productivity tool kit for building intelligent agents using machine learning and reasoning. The ABLE framework provides a set of Java™ interfaces and base classes used to build a library of JavaBeans called AbleBeans. The library includes AbleBeans for reading and writing text and database data, for data transformation and scaling, for rule-based inferencing using Boolean and fuzzy logic, and for machine learning techniques such as neural networks, Bayesian classifiers, and decision trees.

The modification service 18 of the execution module 12 is realized as Rule Engine 122′. The rule engine receives data and applies pre-defined or dynamically deployed rules to the data. The engine returns either true or false based on the evaluation of data. The Adaptive Entities (AEs) 121′ are stateful business objects, where the state-adaptive behavior is modeled using finite state machines. Therefore, state transitions are executed following the Event/Guard/Action principle. Events requesting a state transition are evaluated based on guard methods. If the evaluation supports a state transition, the action is executed, and the state machine moves into the next state. The AE itself is an Enterprise JavaBean (EJB) deployed by the AE engine 121′. The AE engine 121′ has a controller unit, which manages the states. State transitions are triggered by events sent by clients to the AE engine 121′. The AE engine 121′ passes the event data to the rule engine 122′. The rule engine 122′ applies rules (which correspond to the guard conditions for a state transition) and either accepts or rejects the state transition (thereby influencing the behavior of the state machine). The controller unit of the AE engine 121′ will invoke the action (a public method on the AE engine) and moves the state machine into the next state.

The knowledge service 103 acts as a simple external client to the BPbot requesting a specific change of the process flow. An external knowledge resource acting as a client requests a change of a process flow. A message with decisions is sent to the in-queue 31 of a JMS service exposed by the manager service run-time 14. The run-time is a standard application server. The manager service 14 is a subscriber for messages from the knowledge service and parses the message to create an instruction set. This instruction set is translated into rules sets and is sent to the rule engine 122′. The rule engine will now contain rules associated to the data passed with a state-transition triggering event. The manager service 14 sends the event (including business data) to the adaptive entity engine 121′ to request a state change. The state machine invokes the rule engine 122′ and passes the data received with the event from the managerial module 10. The rules previously deployed by the managerial module are applied to the data. The rule engine 122′ determines whether the transition can occur. The transition can only occur if the rules applied are true. The state machine executes the state transition and returns a message to the manager service 14. The manager service 14 places the message on the JMS out-queue 32 to be picked up by an interested receiver.

BPbot composition is an important feature to enable business process management systems, which can dynamically adapt themselves to changing business conditions. Several BPbots will work together to achieve a certain goal. The organization of BPbots will depend on the specific business situation.

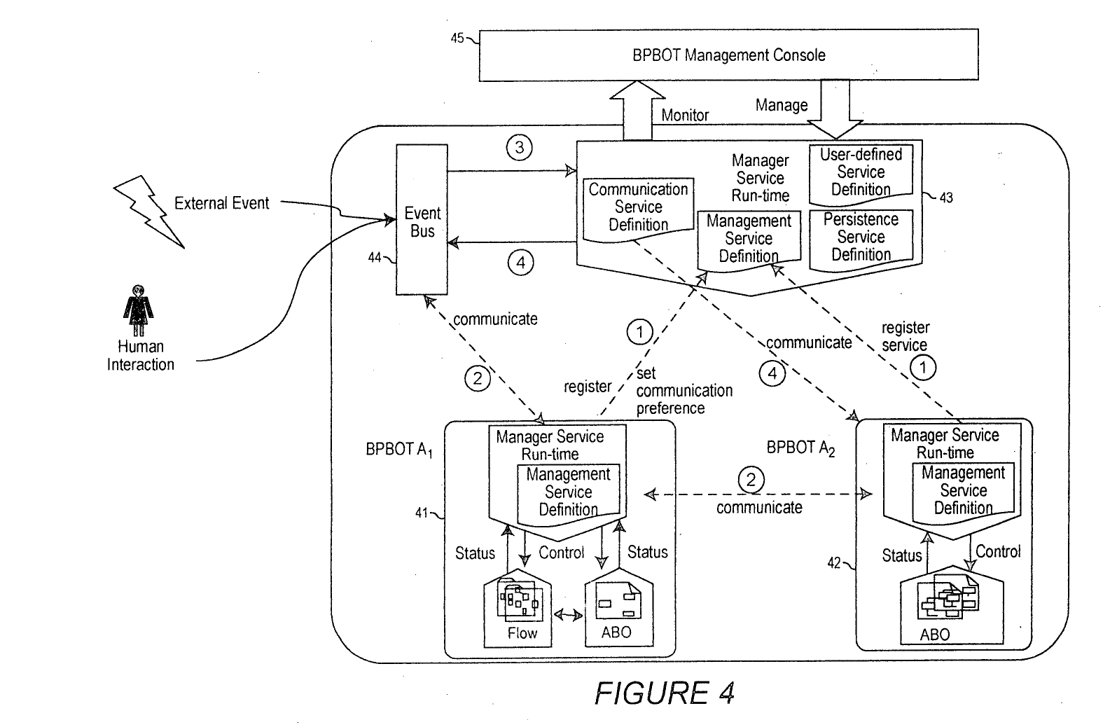

FIG. 4 illustrates a hierarchical organization of BPbots. There are two BPbots 41 and 42, which work independently on a given business aspect. BPbots 41 and 42 are unaware of each other's existence and are also unaware of the global business goal to be achieved. This information resides in the managerial component 43, which manages both BPbots 41 and 42. Hence, the entire construct is a BPbot 40 itself with a managerial module (the managerial component 43) controlling two execution modules (the BPbots 41 and 42), where both execution modules are themselves BPbots consisting of managerial modules and execution modules.

In the example shown in FIG. 4, BPbots 41 and 42 register their services at the management service 43. Also BPbots 41 and 42 set their communication preferences. The communication preferences are either peer-to-peer or sending events to the event bus 44. The managerial service 43 will receive events from the environment and from the internal BPbots 41 and 42 via the event bus 44 and process the events, using the management services available. The management service 43 can communicate to the appropriate BPbot 41 or 42 either directly or through publishing an event to the event bus 44. The BPbot management console 45 is a dashboard, which receives information about the internal state of the entire BPbot 40 through the managerial service 43. Also, the managerial service 43 can receive requests for changes through the management console 45.

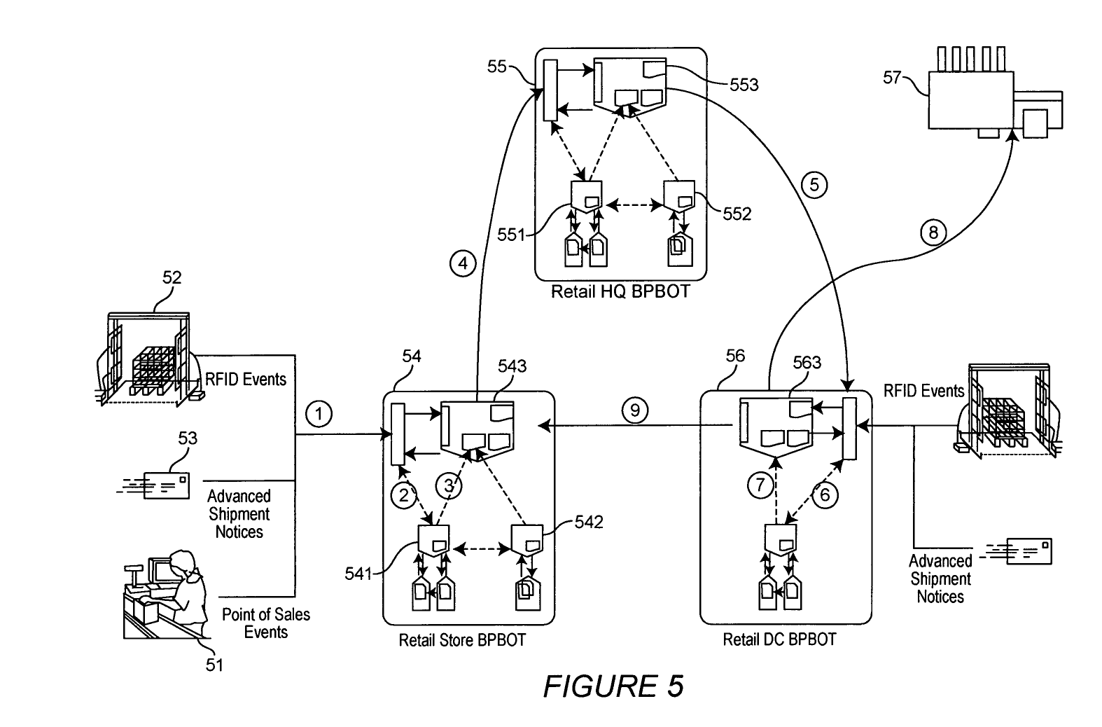

FIG. 5 illustrates the application of the invention to the retail industry for a simple replenishment process. A retail store receives pont of sales events 51 every time a product is sold at the counter. Radio frequency identification (RFID) events 52 notify the arrival of goods at the backroom. The retail store also receives advanced shipment notices 53 about goods shipped out to be received soon. The retail store BPbot 54 evaluates the incoming events and determines if there is a potential out of stock situation. The retail store BPbot 54 consists of two BPbots 541 and 542 (similar to FIG. 4), one determining potential out of stock situations, and the other handling the out-going shipment orders. Assume that the two internal BPbots have determined an out-of-stock threat due to unexpectedly strong sales for a product. This event is sent to the BPbot manager 543, which sends the messages to the Retail Headquarters (HQ) BPbot 55. The HQ BPbot 55 has visibility over the entire supply chain and more knowledge to ascertain the urgency of the situation. The managerial module 553 of the BPbot 55 receives the message and initiates a process in one of the internal BPbots 551 or 552 to elucidate the situation. Finally, the HQ BPbot 55 creates an execution plan, which is sent to the distribution center (DC) BPbot 56. The DC BPbot 56 receives the execution plan from the HQ BPbot 55 and initiates the execution by applying the procedure as described above. Due to the urgency of the out of stock situation, the execution plan requires a one time expedited delivery to the retail store. The rules for execution are deployed to the modification service of the DC BPbot 56, and the process is changed accordingly. The expedited shipment order is created and sent to the managerial module 563 of the DC BPbot 56. The managerial module 563 sends a replenishment order for the product to the supplier 57. The managerial module 563 unit also notifies the Retail Store BPbot 54 of the expedited shipment and its expected arrival date (Advanced Shipment Notice 58).

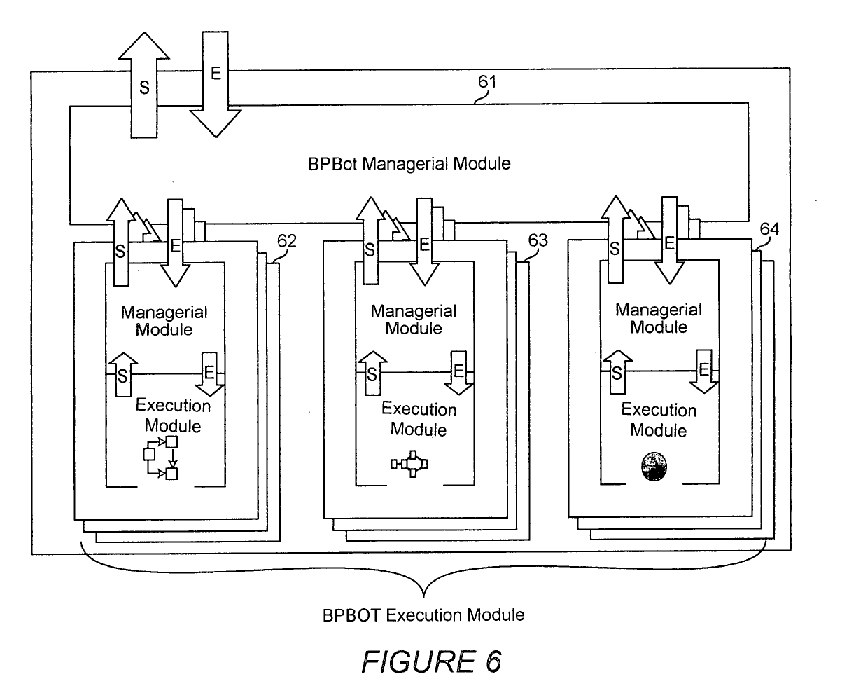

Depending on the application, the BPbots may be more or less complex than the model shown in FIG. 4 and applied in the application illustrated in FIG. 5. In general, the BPbot business process level can contain several nested BPbots, as generally illustrated in FIG. 6. The BPbot managerial module 61 reports information from the business process to the outside world and receives events from the outside and knows how to respond to these events. The managerial module manages a plurality of nested BPbots 62, 63 and 64, each with its own managerial module and execution module and each operating autonomously from one another.

While the invention has been described in terms of a single preferred embodiment, those skilled in the art will recognize that the invention can be practiced with modification within the spirit and scope of the appended claims.

1. A system for extracting and managing a business process that can automatically adapt the process to changing business conditions comprising:
a data source containing quantified business goals;
an execution module that can govern execution of the process; and
a managerial module that can monitor process performance and can modify the business process to achieve the business goals.

2. The system recited in claim 1, wherein the execution module comprises:
a definition of the business process steps and sequencing rules for the steps; and
means for executing the process according to the definition.

3. The system recited in claim 2, wherein the means for executing the process according to the definition comprises a workflow engine or means to invoke a workflow engine.

4. The system recited in claim 2, wherein the means for executing the process according to the definition comprises a state machine engine or means to invoke a state machine engine.

5. The system recited in claim 1, wherein the managerial module comprises:
a knowledge base governing how to modify the business process based on business goals; and
means for modifying the execution module so as to modify the business process executed by the execution module.

6. The system recited in claim 1, wherein the managerial module detects changes in conditions external to the business process and modifies the business process such that the business goals can be met under changed conditions.

7. The system recited in claim 6, wherein the managerial module communicates to external entities conditions of the business process it manages.

8. The system recited in claim 7, wherein conditions detected by the managerial module include conditions of like systems that execute and manage other business processes.

9. The system recited in claim 1, wherein the managerial module is capable of forming requests and instructions, and sending, receiving and parsing execution model scripts.

10. The system recited in claim 1, wherein the execution module comprises one or more execution modules with corresponding managerial modules and further comprises a manager service managing the one or more execution modules and corresponding managerial modules.
